(19) United States
(12) Patent Application Publication
(10) Pub. No.: US 2012/0306138 A1
(43) Pub. Date: Dec. 6, 2012

(54) CLAMPING DEVICE

(75) Inventor: BING-JUN ZHANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen (CN)

(21) Appl. No.: 13/221,838

(22) Filed: Aug. 30, 2011

(30) Foreign Application Priority Data
Jun. 2, 2011 (CN) 201110147562.5

(51) Int. Cl. B25B 5/16; B25B 5/10

(52) U.S. Cl. 269/244

(57) ABSTRACT

A clamping device includes a supporting base, a frame member, two slidable members, and a bolt. The frame member is mounted on the supporting base and defines a through hole. The frame member further defines two mounting holes on two opposite walls of the through hole. Each slidable member comprises a clamping portion and a matching portion connected to each other, each clamping portion defines a clamping surface. The clamping surface defines clamping grooves. A saw-toothed structure is formed on an inner wall of each clamping groove. Each matching portion is received in the through hole and defines a threaded hole. The bolt is threaded and passes through the threaded holes. The threads of the bolt engage with the threaded holes, two ends of the bolt are respectively received in the mounting holes. The two slidable members slide towards or slide away from each other when the bolt is rotated.

### BACKGROUND

1. Technical Field

The present disclosure relates to a clamping device.

2. Description of Related Art

Usually, the proof or yield strength (anti-torque strength) of a screw or a bolt is tested using a torque wrench. During testing, the screw or the bolt is twisted into a threaded hole with the torque wrench. The torque wrench simultaneously provides a lateral force and a torque to the screw or the bolt. However, the screw or the bolt may be tilted by the lateral force, and torque testing with the torque wrench is not accurate when the screw or the bolt is tilted.

Therefore, it is desirable to provide a clamping device, which can overcome the limitations described.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views, and all the views are schematic.

FIG. 1 is a schematic, isometric view of a clamping device including a clamping portion according to an embodiment of the present disclosure.

FIG. 2 is an exploded view of the clamping device of FIG. 1.

FIG. 3 is a schematic, cutaway view of the clamping device of FIG. 1.

FIG. 4 is a cross-sectional view, taken along line IV-IV of the clamping device of FIG. 1.

FIG. 5 is an enlarged view of the clamping portion of FIG. 2.

### DETAILED DESCRIPTION

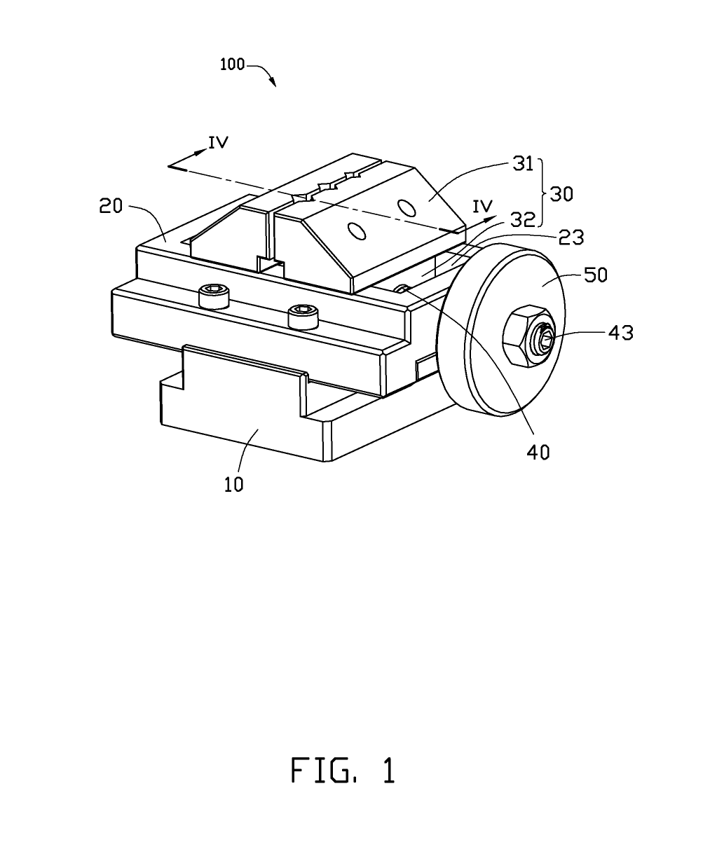

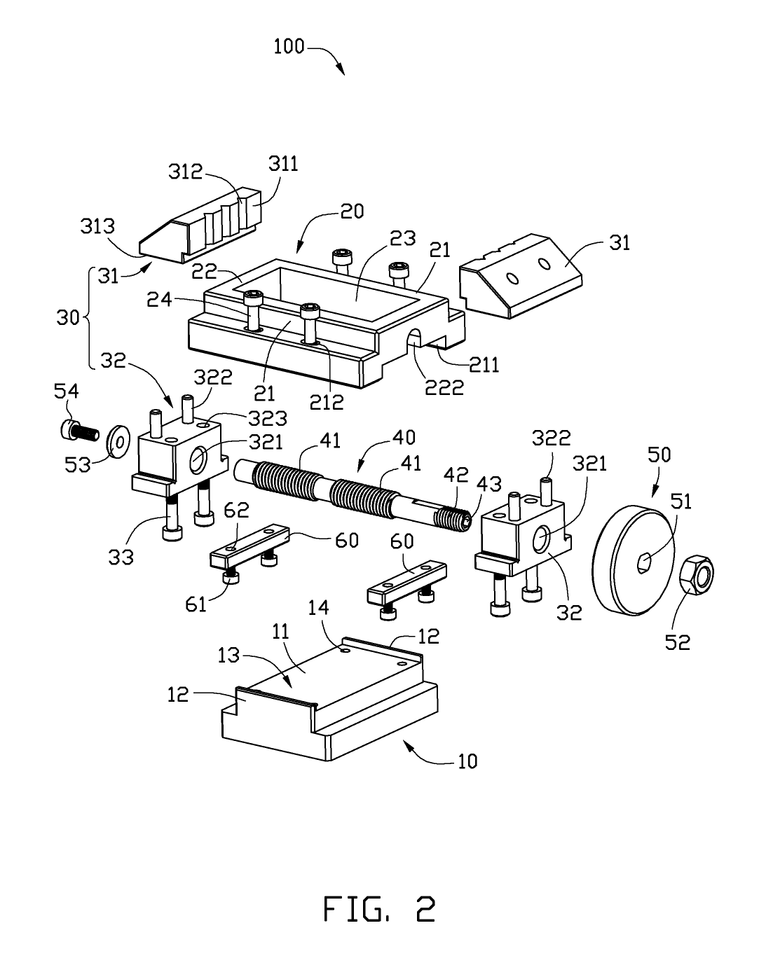

Referring to FIGS. 1 and 2, a clamping device 100, according to an exemplary embodiment, includes a supporting base 10, a frame member 20, two slidable members 30 and a bolt 40.

The supporting base 10 is a stepped block, and includes a top surface 11. Two sidewalls 12 perpendicularly extend from two opposite sides of the top surface 11. The top surface 11 and the sidewalls 12 cooperatively define an opening 13. In the opening 13, screw holes 14 are defined in the top surface 11 adjacent to the sidewalls 12.

The frame member 20 is mounted on the supporting base 10 and includes a pair of first sidewalls 21, a pair of second sidewalls 22 substantially perpendicular to the first sidewalls 21, and a through hole 23 surrounded by the first sidewalls 21 and the second sidewalls 22. The through hole 23 is stepped. The bottom part of the through hole 23 is wider than the top part of the through hole 23. The bottom part of the through hole 23 includes an open end 211 defined in the second sidewalls 22. Each second sidewall 22 defines a mounting hole 222 passing through the corresponding second sidewall 22 and is in communication with the open end 211. Two mounting holes 222 of the two second sidewalls 22 align with each other. Each first sidewall 21 is stepped and includes a surface defining fixing holes 212 corresponding to the respective screw holes 14 on the supporting base 10. The fixing holes 212 are oval-shaped. The length of the fixing hole 212 is greater than the diameter of the screw hole 14.

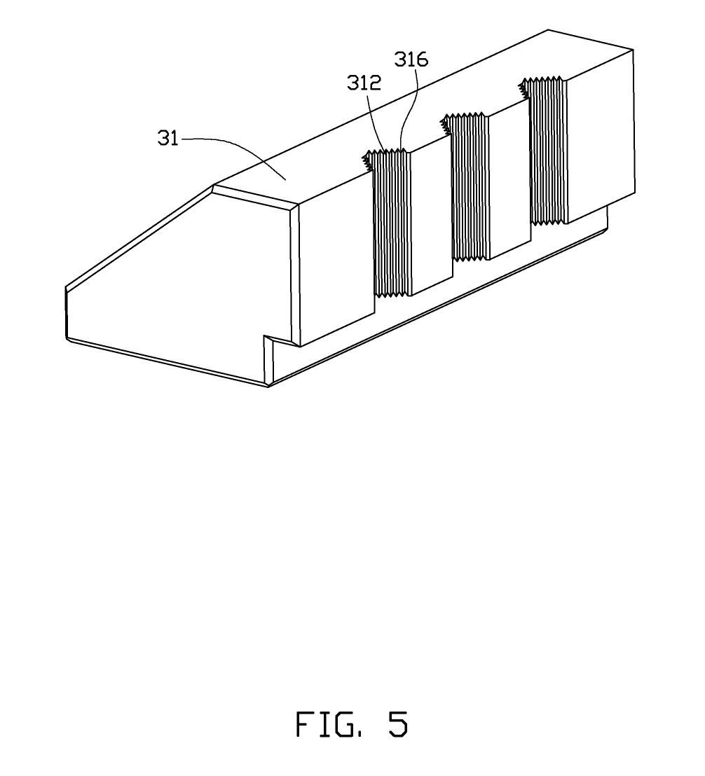

Each slidable member 30 includes a substantially triangular clamping portion 31 and a substantially cuboid matching portion 32. Each clamping portion 31 includes a contacting surface 313 and a clamping surface 311 substantially perpendicular to the contacting surface 313. The contacting surface 313 contacts with the pair of the first sidewalls 21. The clamping surface 311 defines a number of V-shaped clamping grooves 312. The V-shaped clamping grooves 312 are spaced apart from and parallel to each other. Each clamping groove 312 of one of the clamping portions 313 corresponds to a clamping groove 312 of the other clamping portions 313. Referring to FIG. 5, tiny saw-toothed structures 316 are formed on an inner wall of each clamping groove 312. Each clamping portion 31 defines pin holes 314 in the contacting surface 313.

Each matching portion 32 defines a threaded hole 321. Two threaded holes 321 of the two matching portions 32 align with each other. One of the threaded holes 321 is left hand threaded and the other is right hand threaded. Each matching portion 32 includes pins 322 extending towards the corresponding clamping portion 31.

The bolt 40 defines two spaced first exterior threads 41 in the middle portion corresponding to the two threaded holes 321. The bolt 40 further defines a second exterior thread 42 adjacent an end of the bolt 40. A hexagon hole 43 is defined in an end surface of the bolt 40 adjacent to the exterior thread 42, and a screw hole 44 is defined in the other end surface of the bolt 40.

The clamping device 100 further includes a wheel 50 and two blocks 60. The wheel 50 defines a screw hole 51 corresponding to the exterior thread 42 of the bolt 40.

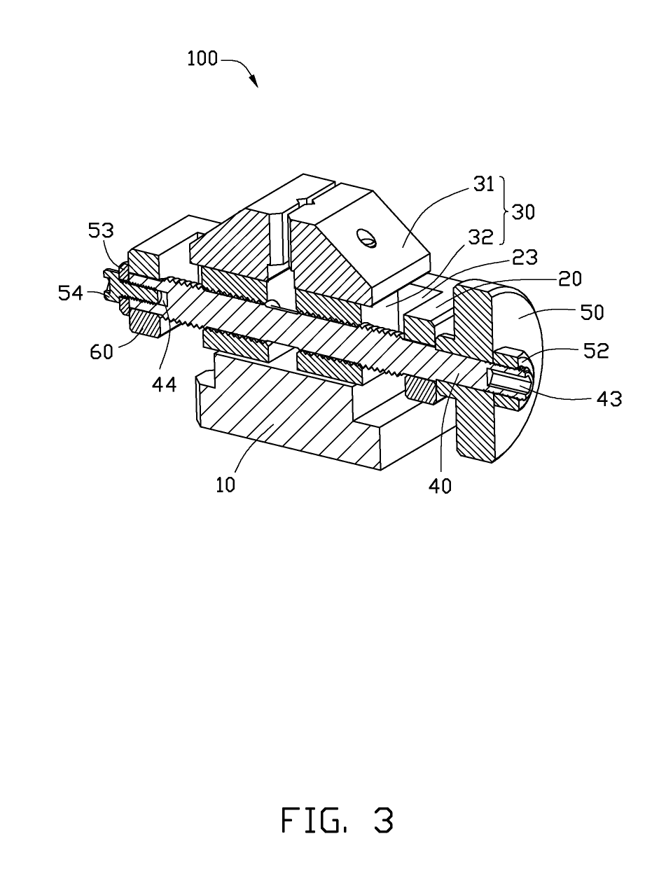

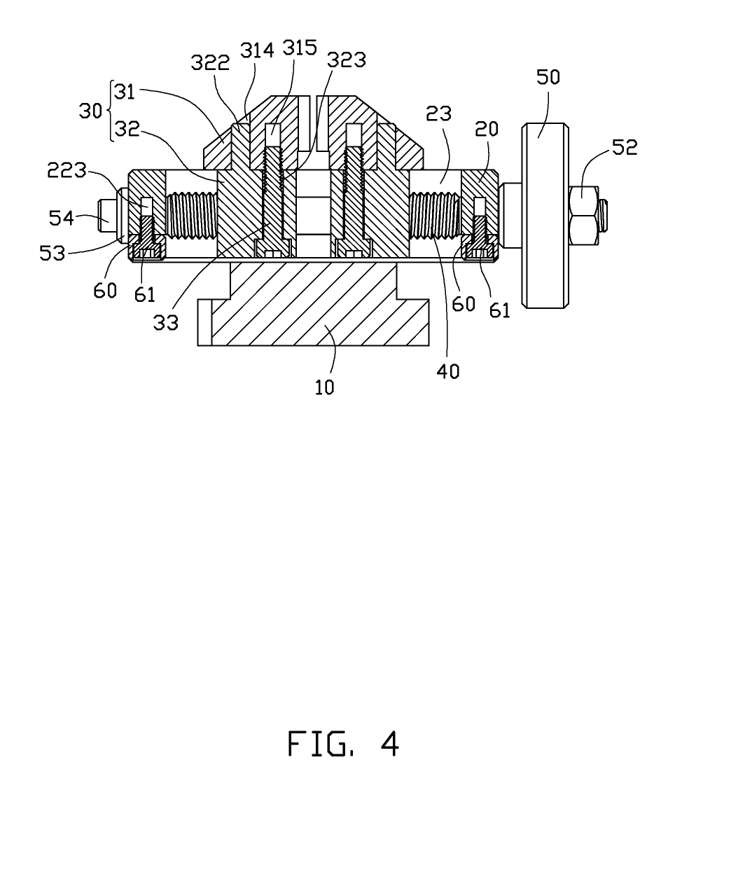

Referring to FIGS. 3 and 4, when assembling, the two first exterior threads 41 are respectively engaged with the two screw holes 321 of the two matching portions 32. The two matching portions 32 can be slid towards each other or slid away from each other when the bolt 40 is rotated. The two matching portions 32 are received in the through hole 23. The pins 322 are inserted into the pin holes 314. Screws 33 extend through holes 323 defined in the matching portions 32 and are inserted into screw holes 315 defined in the contacting surface 313 of the clamping portions 31, thus to fix the matching portions 32 on the clamping portions 31 together. Two ends of the bolt 40 are respectively received in the two mounting holes 222. Screws 61 extend through holes 62 defined in the blocks 60 and are inserted into screw holes 223 defined in the frame member 20, thus to mount the blocks 60 in the open end 211. The blocks 60 keep the two ends of the bolt 40 in the two mounting holes 222. The wheel 50 is mounted on the bolt 40 by engagement of the screw hole 51 and the second exterior thread 42 and is fixed by a nut 52. A sleeve 53 is mounted on the other end of the bolt 40 and is fixed by a screw 54 inserted in the screw hole 44 of the bolt 40. Screws 24 extend through the fixing holes 212 and are inserted into the screw holes 14 to fix the frame member 20 on the supporting base 10. As the fixing holes 212 are oval-shaped, the position of the frame member 20 relative to the supporting base 10 can be adjusted by changing the positions of the screws 24 in the fixing holes 212.

When in use, the wheel 50 is turned to rotate the bolt 40 to make the two slidable members 30 slide away from each other. The fastener 200 is put in the clamping grooves 312 and the head of the fastener 200 is exposed out of the clamping grooves 312. Then the wheel 50 is turned to make the two slidable members 30 slide toward each other to clamp the fastener 200. The saw-toothed structure 316 in the clamping grooves 312 helps the slidable members 30 to hold the fastener 200 more tightly. Then, the fastener 200 can be tested by a torque testing device without risk of the fastener 200 becoming tilted.

When the torque applied to the fastener 200 is too much, a hexagon spanner can be engaged with the hexagon hole 43 to apply forces to clamp the fastener 200 tightly.

It will be understood that the above particular embodiments are shown and described by way of illustration only. The principles and the features of the present disclosure may be employed in various and numerous embodiments thereof without departing from the scope of the disclosure. The above-described embodiments illustrate the scope of the disclosure but do not restrict the scope of the disclosure.

What is claimed is:

1. A clamping device comprising:
a supporting base;
a frame member mounted on the supporting base and comprising a pair of first sidewalls and a pair of second sidewalls substantially perpendicular to the first sidewalls, the frame member defining a through hole surrounded by the first sidewalls and the second sidewalls, each second sidewall defining a mounting hole, two mounting holes of the second sidewalls communicated with the through hole and aligned with each other;
two slidable members, each slidable member comprising a clamping portion and a matching portion, each clamping portion comprising a contacting surface and a clamping surface substantially perpendicular to the contacting surface, the clamping surface defining a plurality of clamping grooves, each clamping groove of one of the clamping portions corresponding to one of the clamping grooves of the other clamping portion, each clamping groove having a saw-toothed structure positioned on an inner wall thereof, each matching portion connected to a corresponding contacting surface, each matching portion received in the through hole and defining a threaded hole, the two threaded holes of the two matching portion aligned with each other; and
a bolt defining exterior threads, the bolt passing through the two threaded holes with the exterior threads engaging with the threaded holes, two ends of the bolt respectively received in the two mounting holes; wherein
the two slidable members are capable of sliding towards each other or sliding away from each other when the bolt is rotated.

2. The clamping device of claim 1, further comprising a wheel mounted on an end of the bolt for turning around the bolt.

3. The clamping device of claim 2, further comprising a sleeve mounted on the other end of the bolt.

4. The clamping device of claim 1, wherein the bolt defines a hexagon hole on an end surface.

5. The clamping device of claim 1, wherein the supporting base comprises a top surface and two third sidewalls extending perpendicularly from two opposite side of the top surface, and the frame member is mounted on the top surface between the two third sidewalls.

6. The clamping device of claim 1, wherein the clamping grooves are V-shaped.

7. The clamping device of claim 1, wherein the clamping grooves of each clamping portion are spaced apart from and parallel to each other.

8. The clamping device of claim 1, wherein the frame member defines oval-shaped fixing holes, the supporting base defines screw holes, the clamping device further comprises screws extending through the fixing holes and plugged into the screw holes to fix the frame member on the supporting base.
